(19) United States
(12) Patent Application Publication
(10) Pub. No.: US 2005/0144397 A1
(43) Pub. Date: Jun. 30, 2005

(54) Method and apparatus for enabling volatile shared data across caches in a coherent memory multiprocessor system to reduce coherency traffic

(76) Inventors: Kevin W. Rudd, Portland, OR (US); Kushagra V. Vaid, San Jose, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/747,977

(22) Filed: Dec. 29, 2003

(51) Int. Cl. G06F 12/00

(52) U.S. Cl. 711/144; 711/145

(57) ABSTRACT

Embodiments include a system for supporting the sharing of volatile data between processors, caches and similar devices to minimize thrashing of a data structure tracking shared data. The system may include a modified, exclusive and shared volatile state. The system may also include a volatile load or read command.

### BACKGROUND

1. Field of the Invention

Embodiments of the invention relate to memory management. Specifically, embodiments of the invention relate to the management and sharing of data in caches.

2. Background

Processors in a computer system typically include a cache for storing recently fetched instructions and data from main system memory. As used herein ‘data’ refers to any information that may be stored in a memory device or similar storage device including instructions. The cache is checked by the processor to determine if needed data is present before retrieving the data from another cache, main system memory or from another storage device.

Computer systems with multiple processors typically communicate between themselves using a system interconnect. Each processor has its own cache. Since these processors may operate on common shared objects, a cache coherency mechanism is used to ensure data consistency. Cache coherency is the guarantee that data associated with an address in the cache is managed between different processors to prevent corruption of the data. Coherency is accomplished by ensuring that different processors operating on the data are aware of the changes made to the data by the other processors. If the other processors are not aware of the changes made by one another then the data in a cache of a processor may become inconsistent with other caches sharing the data or may be lost due to the actions of another processor.

Cache coherency is maintained between processors by signaling changes to a memory address over a shared system interconnect. One coherency mechanism ensures that when a processor updates the memory address, the caches on remote processors containing the memory address are invalidated. This cache coherence mechanism ensures that multiple processors cannot have separately-modified copies of data at the same time.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a block diagram of one embodiment of a multiple processor system.

FIG. 2 is a block diagram of one embodiment of a cache.

FIG. 3 is a flowchart of one embodiment of a process for a management of cache line.

FIG. 4 is a flowchart of one embodiment of a process for a management of a cache line.

FIG. 5 is a state diagram of one embodiment of a process for managing cache line status.

### DETAILED DESCRIPTION

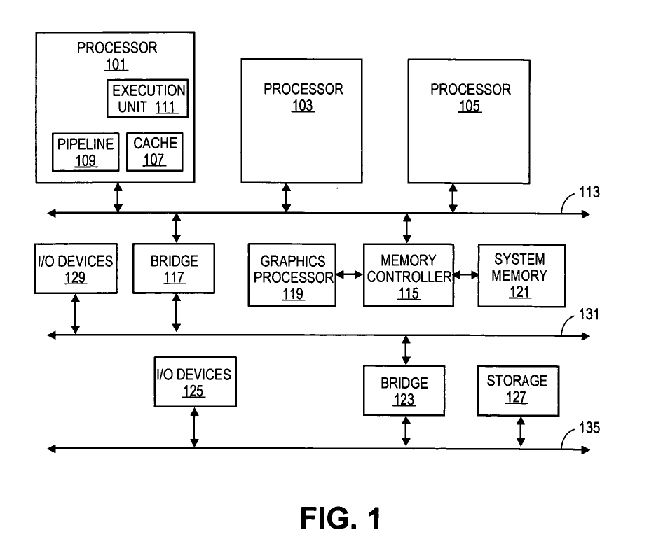

FIG. 1 is a block diagram of one embodiment of a multiple processor computer system. In the exemplary system, a first processor 101, second processor 103 and third processor 105 may be present. In another embodiment, any number or processors may be used in the computer system. The processors may fetch data including instructions and execute the instructions. The instructions may be retrieved from system memory 121. The processors may each have a cache 107 for storing data. Cache 107 may be used to store recently fetched data from system memory 121. Cache 107 may be composed of multiple memory segments or lines to store data and circuitry to allow processor 101 to access and store data in these lines. The instructions and data fetched from system memory 121 may be managed by pipeline 109 to allow the instructions and data to be processed in program order or out of program order by execution units 111.

In one embodiment, the processors may be in communication with one another via an interconnect such as a bus 113. This bus 113 may also enable communication between the subcomponents of the processors such as the caches in each processor. In another embodiment, any other type of communication interconnect may be utilized in place of or in conjunction with bus 113. The processors may also be in communication with a memory controller 115. Memory controller 115 may facilitate the reading and writing of data and instructions to system memory 121. Memory controller 115 may also facilitate communication with a graphics processor 119. In another embodiment, graphics processor 119 may communicate with the processors via bus 113 or may be an input output (I/O) device 129/125 that communicates with the processors via bridges 117 and 123. Graphics processor 119 may be connected to a display device such as a cathode ray tube (CRT), liquid crystal display (LCD), plasma display device or similar display device. In one embodiment, the components connected to bus 113 may communicate with other system components on bus 131 or 135 through bridges 117 and 123. I/O devices 129 and 125 may be connected to the computer system through busses 131 and 135 and bridges 117 and 123. I/O devices 129 and 135 may include communication devices such as network cards, modems, wireless devices and similar communication devices, peripheral input devices, such as mice, keyboards, scanners and similar input devices, peripheral output devices such as printers, display devices and similar output devices, and other I/O devices that may be similarly connected to the computer system. Storage devices such as fixed disks, removable media readers, magnetic disks, optical disks, tape devices, and similar storage devices may also be connected to the computer system.

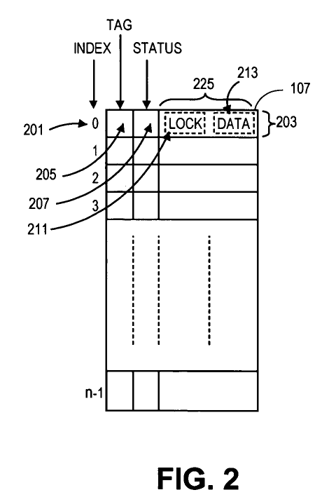

FIG. 2 is a block diagram of one embodiment of an exemplary cache. Memory structure 107 may be a cache containing multiple lines for storing data fetched by a processor or similar device. One method for accessing data that is held in the cache is to select a cache line 203 using an index value computed from the memory address. Tag 205 in the cache line may be compared with a tag value computed from the address. If tag 205 matches the computed tag then the line is the correct line for an address. If tag 205 does not match the computed tag then the line is not the correct line for the address and may require that the data be fetched from memory 121 or another processor's cache. There may be multiple cache lines per index and the comparison may indicate that at most one of the lines is the correct line. Index 201 may be implicit based on the position of a cache line in cache 107.

In one embodiment, cache line 203 includes a status field 207, which indicates the cache coherence protocol state for cache line 203. Cache line 203 may include one or more independent data segments. The contents of cache line 203 may include a data field 225. Data field 225 may contain information tracked by cache line 203 corresponding to information stored at a given address in memory or related to that address. In one embodiment, data field 225 may be interpreted to include a lock field 211 and data field 213. In another embodiment, other cache-line contents may be included and some segments of a cache line may not be used. Status field 207 indicates the current status of cache line 203. For example, dependent on the coherence protocol used, status field 207 may indicate that cache line 203 is in a modified, exclusive, shared, invalid or similar state. In another embodiment, status field 207 may indicate that cache line 203 is in modified volatile, exclusive volatile or shared volatile state. Status field 207 may use an encoding system where multiple states or status types may be represented in enumerated form. In another embodiment, status field 207 may use an unencoded representation and have a single bit per (at least the smallest addressable) data element that represents each state or status type. In a further embodiment, status field 207 may use any combination of encoded and unencoded representations. For example, status field 207 may include a bit that indicates that the cache line includes volatile data.

In one embodiment, a modified state may indicate that cache line 203 has been modified since it has been fetched from its source location such as system memory 121, or from a remote processor cache. A cache line in a modified state may be owned by only one processor and may be incoherent with the related address in system memory 121.

In one embodiment, the exclusive state may indicate that cache line 203 is owned by the processor where the cache resides and has not been shared with other processors or caches. A line in an exclusive state may be owned by only one processor and may be coherent with the related address in system memory 121. Also, this state may indicate that cache line 203 has not been modified since being retrieved or last written back to system memory 121.

In one embodiment, the shared state may indicate that cache line 203 may be shared with another processor or device. For example, if the processor associated with cache 107 fetched the contents of cache line 203 and subsequently another processor requested the same information, then the contents of cache line 203 may be sent to the requesting processor by the processor holding the line in the shared state or may be directly accessed from memory 121 by the requesting processor. A line in a shared state may be held by one or more processors and may be coherent with the related address in system memory 121.

In one embodiment, when cache line 203 is in an exclusive or modified state the owning processor may freely modify the data in cache line 203. When data in cache line 203 is in a shared state the processor may invalidate all copies held in other caches or data structures to become the owner of the cache line before modifying the data.

In one embodiment, the invalid state indicates that cache line 203 contains no usable data and any data that may be stored in the line may not be accessed by the processor associated with cache 107 or by any other cache or processor. A cache line 203 may be marked as invalid when exclusive or modified ownership of a cache line is given to another processor or device. Cache line 203 may be marked as invalid when another processor or device indicates that the cache line should be invalidated or under other similar conditions. If cache line 203 is in a modified state then it may require its contents to be written back to system memory 121 or transferred to the processor receiving ownership.

In one embodiment, the modified volatile state may indicate that cache line 203 contains data that is modified but which may be shared with caches associated with other processors. It may indicate that one segment of the cache line such as lock field 211 may be non-volatile and require that any modifications to this segment of the cache line requires notification of the change to other processors that may or may not hold the line in their caches. It may indicate that another segment of the cache line such as data field 213 may be volatile. The volatile segment of the cache line may be modified without notification to other processors or devices. The lock field 211 may contain non-volatile data that may be coherent between the caches on different processors. The data field 213 may contain volatile data which may be non-coherent between the caches associated with different processors or devices.

In one embodiment, the shared volatile state may indicate that the contents of cache line 203 are shared with another processor or device. The shared volatile state may include status information that identifies that some segment of cache line 203 may be in a volatile state and that some other segment of cache line 203 may be in a non-volatile state.

In one embodiment, the exclusive volatile state may indicate the content of cache line 203 is shared with another process or device and the associated processor or device has ownership. The exclusive volatile state may include status information that identifies that some segment of cache line 203 may be in a volatile state and that some other segment of cache line 203 may be in a non-volatile state. In another embodiment, an exclusive volatile state may not be used.

In one embodiment, status field 207 may indicate the status of individual segments of cache line 203. Status field 207 may indicate that one segment of cache line 203 is volatile and that another segment of cache line 203 is non-volatile. A volatile segment may be a segment that contains data that may be changed by the owning processor without notice to other processors or devices. A non-volatile segment may be a segment that may generate a notification to a sharing processor or device if it is modified by the owning processor or device. In another embodiment, the number or size of volatile or non-volatile segments may be restricted. In a further embodiment, the number and size of volatile and non-volatile segments may not be limited. Multiple volatile and non-volatile segments in a cache line may be identified and may include associating the segments with separate processors or may only include the status of the individual segments. Restrictions on the size or placement of the segments may improve performance by minimizing the effective segment size based on implementation-specific segment number, size, and granularity restrictions.

In one embodiment, the segment status or state may be implicit. In another embodiment the segment status or state may be explicit. For example, an implicit segment status or state might be that the first segment of the line has one state and that the rest of the cache line may have another state. Lock field 211 may be the first segment in the cache line and be designated to be non-volatile and data field 213 may constitute the remainder of the cache line and may be designated to be volatile. In another embodiment, an explicit segment state may be associated with one or more individual segments or each segment may be individually defined to be non-volatile or volatile. The size and position of the segments may be specified explicitly in a field of the cache line or may be defined to correspond to specific segments of the cache line. In one embodiment, a bit vector may identify which segments of the cache line are non-volatile and which segments are volatile. In another embodiment, mechanisms similar to a bit vector and implicit or explicit designation of status may be used.

In one embodiment, the status or state of a segment of a line may be distinct from the state of the line as a whole. A line may be in a shared volatile or modified volatile state yet have segments in a non-volatile state. In one embodiment, a cache line in a shared volatile or modified volatile state has at least one segment in a non-volatile state.

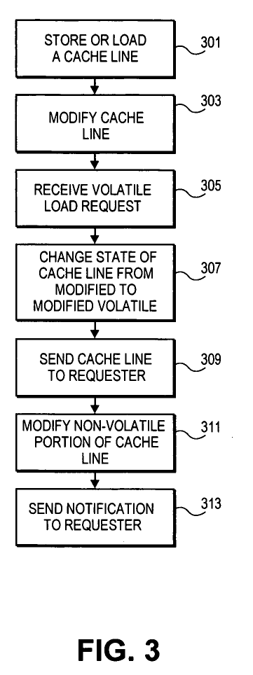

FIG. 3 is a flowchart of one embodiment of a process for management of a cache line supporting a modified volatile state. In one embodiment, the cache stores or loads a cache line (block 301). The new cache line may contain data that had been recently fetched by a processor or device. Data stored may include instructions or other types of data. The cache line may be initially held in an exclusive or modified state. In another embodiment, a cache line may be initially in another state depending on the particular coherence mechanism used.

In one embodiment, if the cache line has not already been stored in a modified state then the cache line may be modified to place it in a modified state (block 303). While the cache line is in a modified state, the cache may receive a volatile read request for the data stored in the cache line (block 305). A volatile read request may come from another processor, device or process. In one embodiment, a volatile read request may be a bus read line volatile (BRLV) request generated by a volatile load request of another processor or device process. The cache may determine that the requested data is present in the cache line and may check the status of the cache line where the requested data is stored.

In one embodiment, if the requested data is in the cache and the request was for a volatile copy of the line, the cache may set the state of the cache line containing previously modified data to a modified volatile state (block 307). The cache may then send the requested data to the source of the request (block 309) acknowledging the volatile status of the line and that of any segments associated with the request.

In one embodiment, the cache line in the modified volatile state may include a segment that may be designated as volatile and a segment that may be designated as non-volatile. The volatile segment may be modified by the owning processor any number of times. The cache may not need to take any special action to maintain coherence for the modification of volatile segments. A non-volatile segment may also be modified (block 311).

In one embodiment, when a non-volatile segment of a cache line is modified a notification may be sent to processors or devices that have previously requested the data. The notification may be an invalidation command. In another embodiment, the notification may include updated information to allow the update of the previously requested data to match the update of the cache line. This procedure maintains the coherency of non-volatile data held in caches of a computer system. This procedure is also applicable to the management of a cache line supporting an exclusive volatile state except that a cache line in the exclusive volatile state is not modified.

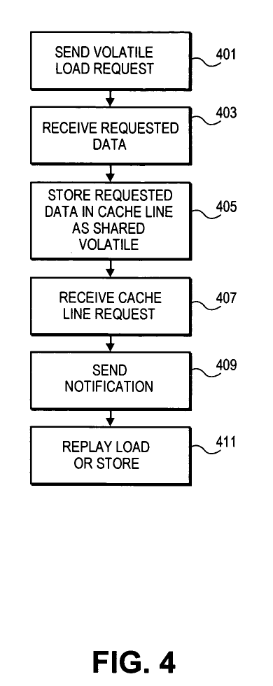

FIG. 4 is a flowchart of one embodiment of a process for cache management that supports a shared volatile state. In one embodiment, a processor or device associated with a cache generates a volatile load request (block 401). A volatile load request may be an instruction that requests data at a memory address be fetched similar to a normal load request. A volatile load request accepts data that may have been modified and that a portion of the requested data may be in a volatile state. The segment requested by the volatile load may be in a non-volatile state. The cache, device, or processor may generate a volatile read request to query other caches to determine if they contain the data requested by the volatile load instruction. In one embodiment, the query is a bus read line volatile (BRLV).

In one embodiment, if the requested data is found then it is returned by the device or processor where it is located (block 403). The data may have been modified data stored in a cache. If the data was retrieved from another cache or similar storage structure where a portion of the data was indicated to be in a volatile state, then it may be stored in a cache line, after retrieval, with an indication that it is in the shared volatile state (block 405). The requested data may indicate that it is non-volatile The requested data may also indicate that the rest of the line is volatile or non-volatile depending on the state of the modified volatile line as well as the capabilities and policies of the system implementation. If additional loads or volatile loads are requested by the associated processor for data that is indicated to be non-volatile then the cache line storing the data in a shared volatile condition may supply the data without changing its state or requesting an updated cache line. In one embodiment, only volatile loads may keep the cache line in shared volatile state and regular loads may perform normal cache coherency transactions as if the shared volatile state was invalid instead.

In one embodiment, if data is stored in a shared volatile state and a load, volatile load, store or similar command is received that requires non-volatile access to data held in a volatile state then the cache line may be invalidated (block 407). The shared volatile cache line may be indicated as in an invalid state and an invalidation notification may be sent to other processors if a non-volatile load or store operation triggered the invalidation (block 409). As a result a load or store may be replayed in a pipeline of a processor, device or process that received the invalidation notification (block 411). In another embodiment, if data is stored in a shared volatile state and a load, volatile load, store or similar command is received that requires non-volatile access to data held in a volatile state then the appropriate request may be made and the cache line refetched or updated appropriately with a load or some subsequent instruction waiting for the updated or replaced data to become available.

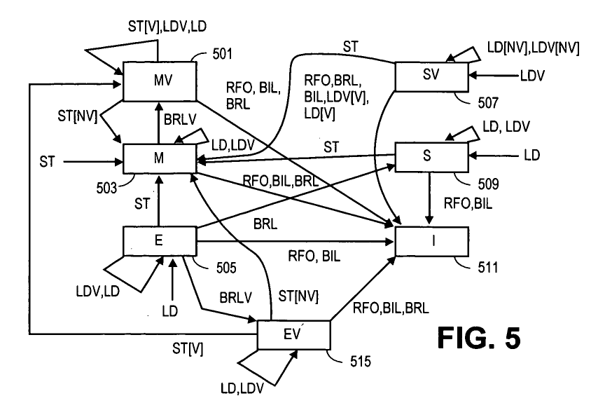

FIG. 5 is a state diagram of one embodiment of a process for the operation of a cache supporting modified volatile, exclusive volatile and shared volatile states. In one embodiment, the cache will utilize seven states to describe the contents of each cache line, or segments of each cache line. In another embodiment, the exclusive volatile state may not be utilized. In a further embodiment, any combination of shared volatile, modified volatile and exclusive volatile or equivalent states may be utilized with any data coherence protocol.

In one embodiment, a cache line may be created by loading or storing data that has been fetched by an associated processor or device. A load instruction may be a load (LD) or volatile load (LDV). A load may result in the new cache line being designated as in an exclusive (E) 505 or shared (S) state 509. The loaded cache line may be exclusive 505 if it is owned by the processor or device that fetched the data and not shared with another processor or device. The loaded cache line may be shared if it is not owned by the processor or device that requested the data.

In one embodiment, a cache line may remain in an exclusive state (E) 505 if subsequent load instructions are received for the same data. A request to read the data by another processor or device may result in a transition to a shared state. A bus read line (BRL) is an example of a read request received from another processor. A request for ownership of the cache line by another processor or device may result in the transition of the cache line to an invalid state 511. A request for ownership (RFO) is an example of a request received from another processor for ownership. Receiving an instruction to invalidate the cache line may also result in the cache line being transitioned to the invalid state 511. A bus invalidate line (BIL) is an example of a request from another processor to invalidate a cache line. A store (ST) or modification of the cache line may result in the cache line being transitioned to a modified state 503. In one embodiment, receiving a volatile read request may result in a transition to an exclusive volatile state 515.

In one embodiment, a cache line in a shared state 509 may remain in the shared state if a load or volatile load request are received for the data in the cache line. A cache line in a shared state 509 may be transitioned to an invalid state 511 if an invalidation request such as a BIL or similar request is received. In one embodiment, the cache line having a shared state 509 may be transitioned to an invalid state 511 if a store (ST) request is received. In this scenario the cache line may then be transitioned from an invalid state 511 to a modified state 503. In another embodiment, a cache line having a shared state 509 may be transitioned directly to a modified state 503. Any combination of transitions between states that occur in succession may be replaced with a direct transition. Also, a shared cache line may be transitioned to an invalid state 511 if a request for ownership (RFO) or bus invalidate line (BIL) is received.

In one embodiment, a modified volatile, exclusive volatile or shared volatile line with all elements marked as non-volatile may be equivalent to a modified, exclusive or shared line respectively. In one embodiment, a volatile data element may be considered to be an invalid data element.

In one embodiment, the new cache line may be designated as in a shared volatile (SV) state 507 if loaded by a volatile load instruction. A cache line may remain in a shared volatile state 507 if it receives additional load or volatile load requests for data stored in the cache line that is indicated to be non-volatile. If a load or volatile load request for data indicated to be non-volatile (LD[NV], LDV[NV]) is received then the cache line in a shared volatile state 507 may remain in a shared volatile state 507. If a load or volatile load request for data indicated to be volatile (LD[V], LDV[V]) is received then the cache line may be transitioned to an invalid state 511.

In one embodiment, a cache line may be placed in a modified state (M) 503 if it was in an exclusive state 505, exclusive volatile state 515 or other state where a direct transition is enabled and a modification of the cache line or store to the cache line occurs. A cache line may remain in a modified state 503 if a load request, store request or volatile load request is received. If a volatile read line request is received such as a bus read line volatile (BRLV) then the cache line may be transitioned to a modified volatile state 501. If a request for ownership or a request to invalidate the line is received then the cache line may be transitioned to an invalid state 511.

In one embodiment, a cache line in a modified volatile (MV) state 501 may remain in the modified volatile state 501 if a load (LD) request or volatile load request (LDV) is received or if a store (ST[V]) is received that modifies a volatile segment of the cache line. A cache line in a modified volatile state 501 may transition to a modified state 503 if a store (ST[NV]) is generated that modifies the non-volatile portion of the cache line. Also, notification of the change to the non-volatile portion of the cache line may be sent to other processors or devices that have requested the cache line. In one embodiment, the notification may be an invalidation command. In another embodiment, the notification may be an update of the cache line to reflect the modification. If an update is sent then the cache line may remain in a modified volatile state. If a request for ownership, a request to invalidate a line, or a read line request is received from another processor or device then the cache line may be transitioned to an invalid state 511. A cache line may be subsequently written back to system memory 221 or transferred to the requesting processor.

In one embodiment, a cache line may be transitioned into an exclusive volatile state (EV) 515 from an exclusive state 505 if a volatile read request is received such as a BRLV. A cache line in exclusive volatile state 515 may be transitioned to an invalid state 511 if a request for ownership, invalidation request or read request is received. In one embodiment, if a store (ST[NV]) to a non-volatile segment of a cache line is received, the cache line may be transitioned to a modified state 503. In another embodiment, the notification may be an update of the cache line to reflect the modification. If an update is sent then the cache line may be transitioned to a modified volatile state. If a store (ST[V]) to a volatile segment of a cache line is received, the cache line may be transitioned to a modified volatile state 501 may be received. If a load request or volatile load request are received the cache line may remain in exclusive volatile state 515.

The state diagram of FIG. 5 is exemplary and the transition instructions and requests may be implemented in other similar configurations. In addition, other instruction types may initiate transitions or similarly affect the state of a cache line. For example, an atomic exchange (xchg) or compare and exchange (cmpxchg) instruction in some architectures may function similar to a load command. Further, variations of state affecting instructions or requests may be implemented to utilize the volatile states. For example, a volatile compare and exchange (cmpxchg.v) instruction or similar volatile instruction or request may be implemented in an embodiment.

In one embodiment, a cache implementing the shared volatile, exclusive volatile and modified volatile state may support lock monitoring and similar consumer-producer mechanisms with minimal thrashing of the supporting data structure such as a cache. For example, a first processor may hold a lock associated with a critical section of a piece of code. A second processor may be waiting to access the same critical section. The second processor may obtain a copy of the cache line with the lock in a non-volatile segment and the remainder of the cache line in a volatile segment. The second processor may hold the data in a shared volatile state in a cache. The first processor may hold the data in a modified volatile state in a cache. The second processor may then periodically check the state of the lock without having to obtain ownership of the cache line thereby avoiding thrashing. An exemplary table showing the minimal number of memory fetches and cache-transfers in this scenario is presented below:

TABLE I

| | | | | Cache to | |
|---|---|---|---|---|---|
| | | | Line | Cache | Memory |
| Processor 1 | Line State | Processor 2 | State | Transfers | Fetch |
| Event | Cache | Event | Cache | Count | Count |
| Acquire | Modified | None | Invalid | 0 | 1 |
| Lock | | | | | |
| None | Modified | Read Lock | Shared | 1 | 1 |
| | Volatile | (w/Volatile | Volatile | | |
| | | Read | | | |
| | | Request) | | | |
| Read Data | Modified | None | Shared | 1 | 1 |
| (in volatile | Volatile | | Volatile | | |
| section) | | | | | |
| None | Modified | Check Lock | Shared | 1 | 1 |
| | Volatile | (Volatile | Volatile | | |
| | | Read | | | |
| | | Request) | | | |
| Write Data | Modified | None | Shared | 1 | 1 |
| (In Volatile | Volatile | | Volatile | | |
| Section) | | | | | |
| None | Modified | Check Lock | Shared | 1 | 1 |
| | Volatile | (Volatile | Volatile | | |
| | | Read | | | |
| | | Request) | | | |
| Release | Modified | None | Invalid | 1 | 1 |
| Lock | | | | | |
| None | Modified | Check Lock | Shared | 2 | 1 |
| | Volatile | (Volatile | Volatile | | |
| | | Read | | | |
| | | Request) | | | |
| None | Invalid | Acquire | Modi- | 2 | 1 |
| | | Lock | fied | | |

In the above example, two cache transfers were made and a single memory fetch. In comparison, a system that did not implement the shared volatile, exclusive volatile and modified volatile states along with a volatile load instruction would have required at least one memory fetch for each read of the lock by the second processor because ownership would be transferred between the processors. In addition, multiple cache to cache transfers would be likely. This system may facilitate multithreaded code that operates on data structures where the lock and data are part of the same structure. For example, these data structures may use per object locking semantics. Managed runtime just in time compilers such as the java virtual machine, produced by Sun Microsystems, and the .NET environment, produced by Microsoft Corporation, generate code that may benefit from a shared, exclusive and modified volatile state system. Other shared-memory multiprocessor applications may also benefit from a shared, exclusive and modified volatile state system.

In one embodiment, this system may be utilized in any producer consumer scenario to improve the management of the system resources. Other systems may include shared cache architectures, shared resource architectures, simulated architectures, software based resource management including mutual exclusion mechanisms and similar resource management systems. In one embodiment, the system may be used in systems other than multiprocessor systems including network architectures, input/output architecture and similar systems. For example, the system may be utilized for sharing data between a direct memory access (DMA) device, graphics processor and similar devices connected by an interconnect and utilizing a shared memory space. Exemplary embodiments described herein in the context of a multiprocessor system are equally applicable to other contexts, devices and applications. The system may be utilized for purposes beyond simple memory coherence schemes. The system may be used as a messaging system between multiple consumers and producers in a system sharing a resource. The modification or accessing of a resource may instigate the sending of notification to other consumers or producers thereby providing them with an update of the status of the resource.

In one embodiment, a system implementing volatile states may have a modified bus or interconnect to support the transmission of one or more bits that indicate the volatile status of cache line transfers. For example, system bus 113 may include an additional control line to transmit a volatile status indicator during cache line transfers between processors. The additional control line may be used to identify volatile load and read requests. System bus 113 may include additional select lines to identify the requested element for the transaction. The extra select lines may be used to identify which element of the cache line is requested to be returned in a non-volatile status.

In another embodiment, any interconnect type utilized for communication in a computer system may be utilized with the embodiments of the volatile state system. In another embodiment, some or all of the extra lines may be implemented by redefining or extending the use of existing lines. In another embodiment, some or all of the extra lines may be implemented using new signal encodings. In another embodiment, a new technique may be used to transmit the volatile request and requested-element information. In another embodiment, some combination of new lines, redefined or extended lines, new signal encodings, or other technique may be used to transmit the volatile request and requested-element information.

In one embodiment, a computer system including a device or processor that supports a shared, exclusive or modified volatile state may be compatible with a processor or device that does not support the shared, exclusive or modified volatile state. A processor or device that does not support the volatile states will utilize the load and read request commands that utilize the basic modified, exclusive, shared and invalid states. In the event that a cache line in a supporting processor is already in the volatile state and a processor that does not support the volatile states makes a load request, the owning processor may invalidate the line in all caches prior to supplying the cache line to the non supporting processor.

The volatile state system including supporting instructions may be implemented in software, for example, in a simulator, emulator or similar software. A software implementation may include a microcode implementation. A software implementation may be stored on a machine readable medium. A “machine readable” medium may include any medium that can store or transfer information. Examples of a machine readable medium include a ROM, a floppy diskette, a CD-ROM, an optical disk, a hard disk, a radio frequency (RF) link, and similar media and mediums.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense. For example, other protocol systems using memory coherence management states other than the modified, exclusive, shared and invalid states may be used in conjunction with the shared, modified, and exclusive volatile states. The embodiments are compatible with any memory coherence scheme and provide an augmented system of sharing data by designating subsets of the data as being in a volatile or non-volatile state.

1. A method comprising:
filling a cache line;
receiving a first request for a first segment of the cache line;
indicating at least the first segment is in a non-volatile state; and
sending at least the first segment while maintaining the cache line in one of a modified volatile state and an exclusive volatile state.

2. The method of claim 1, further comprising:
modifying at least a portion the first segment of the cache line; and
sending a notification of the modification.

3. The method of claim 1, further comprising:
modifying a second segment of the cache line without generating a notification of the modification; and
indicating the second segment is in a volatile state.

4. The method of claim 1, wherein the cache line is a part of a first cache associated with a first processor.

5. The method of claim 4, further comprising:
sending data from the cache line to a second cache associated with a second processor.

6. The method of claim 3, further comprising:
receiving a second request for a different third segment of the cache line; and
sending at least the third segment of the cache line while maintaining one of the modified volatile state and exclusive volatile state.

7. The method of claim 6, further comprising:
updating the cache line to indicate the third segment of the cache line is in a non-volatile state.

8. The method of claim 6, further comprising:
updating the cache line such that only the third segment of the cache line is in a non-volatile state; and
invalidating the cache line from all other processors holding the cache line or sending an updated copy of the cache line to a processor.

9. A memory device comprising:
a plurality of memory segments to track a volatile status for a subset of a memory segment; and
circuitry to allow access to the plurality of memory segments.

10. The device of claim 9, wherein the volatile status is a modified volatile status.

11. The device of claim 9, wherein the volatile status is a shared volatile status.

12. The device of claim 9, wherein the volatile status is an exclusive volatile status.

13. A method comprising:
executing a first volatile load request;
placing requested data in a cache line; and
placing an indication of a shared volatile state associated with the requested data in the cache line.

14. The method of claim 13, further comprising:
executing a load or a second volatile load request for data held in the cache line in a non-volatile state; and
returning the result of the volatile load request.

15. The method of claim 13, further comprising:
executing a load or second volatile load request for a volatile portion of the cache line and placing the cache line in an invalid state.

16. The method of claim 13, further comprising:
executing a load or second volatile load request for a volatile portion of the cache line and receiving an updated copy of the cache line in a shared volatile state with requested data in a non-volatile state.

17. An apparatus comprising:
means for storing data; and
means for tracking one of a shared volatile state, a modified volatile state and an exclusive volatile state for the means for storing data.

18. The apparatus of claim 17, further comprising:
means for indicating one of a first portion and a second portion of a segment of the means for storing data contains non-volatile data.

19. The apparatus of claim 17, further comprising:
means for notifying a second means for storing data that a non-volatile data has been modified.

20. The apparatus of claim 17, further comprising:
means for indicating multiple segments are in one of a volatile and non-volatile state for a line of the means for storing data.

21. A system comprising:
a first cache in a first central processing unit to store a first cache line in one of a shared volatile state, exclusive volatile state, a modified volatile state; and
a second cache in a second central processing unit in communication via a system interconnect with the first cache to store a second cache line.

22. The system of claim 21, further comprising:
a first processor associated with the first cache; and
a second processor associated with the second cache.

23. The system of claim 21, further comprising:
a system memory that is cached by the first and second caches.

24. The system of claim 21, wherein the first cache line indicates at least one non-volatile segment.

25. The system of claim 21, wherein the first cache notifies the second cache of a change in the non-volatile portion of a cache line in one of the modified volatile, the exclusive volatile state, and shared volatile state.

26. A processor comprising:
a pipeline to process instructions in one of program order and out of program order;
a set of execution units to execute the instructions; and
a set of caches coupled to the pipeline to store data required by the pipeline in one of a modified volatile, exclusive volatile, and shared volatile state.

27. The processor of claim 26, wherein the cache generates a notification upon modification of non-volatile data.

28. The processor of claim 26, wherein the cache shares data containing a modified portion.

29. A machine readable medium having instruction stored therein which when executed cause a machine to perform a set of operations comprising:
placing data in a cache line;
indicating the data in the cache line is in one of a modified volatile, exclusive volatile, and shared volatile state; and
sharing the data in the cache line.

30. The machine readable medium of claim 29, having instructions stored therein which when executed cause a machine to perform a set of operations further comprising:
generating a notification when a non-volatile data portion is modified.

31. The machine readable medium of claim 29, having instruction stored therein which when executed cause a machine to perform a set of operations further comprising:
indicating the size and position of a non-volatile portion of a cache line.
